(19) United States
(12) Patent Application Publication
(10) Pub. No.: US 2025/0333286 A1
(43) Pub. Date: Oct. 30, 2025

(54) FILLING VALVE ASSEMBLY

(71) Applicant: Fogg Filler Company, LLC, Holland, MI (US)

(72) Inventor: Trevor R. DODD, Holland, MI (US)

(21) Appl. No.: 19/187,454

(22) Filed: Apr. 23, 2025

Related U.S. Application Data
(60) Provisional application No. 63/638,657, filed on Apr. 25, 2024.

(51) Int. Cl. B67C 3/26; B67C 3/28

(52) U.S. Cl. CPC B67C 3/26; B67C 3/28

(57) ABSTRACT

A method is provided for controlling a filling valve assembly during a container filling operation, wherein the filling valve assembly includes a vent tube for venting air from the container during filling. The method involves utilizing a movement of a valve component to create a negative pressure condition at an upper end of the vent tube to promote air movement upward through the vent tube as the filling valve assembly is being opened for filling. A filling valve assembly configured to carry out the method includes a pressure condition assembly connected to a vent tube of the filling valve assembly.

### TECHNICAL FIELD

This application relates generally to filling machines used to fill liquid into containers and, more specifically, to a filling valve assembly useful in such filling machines.

### BACKGROUND

A typical liquid filling system for containers includes a container handling device, a liquid filling machine and a capping/lidding machine. The container handling device transports unfilled containers to the liquid filling machine and then transports the filled containers from the filling machine to the capping/lidding machine. The container handling device commonly comprises one or more conveyors and may also include one or more indexing devices such as gates, star wheels or spindles.

One type of rotary filling machine includes a plurality of filling stations arranged around the circumference of a revolving filler bowl that holds the liquid to be filled into containers. Each filling station includes a filling device typically having a filling valve, with an associated nozzle, and a container holding device for securely holding and aligning each container as the containers rotate with the filler bowl during the filling process. The valve controls the feed of material down through the nozzle into the container. The nozzles direct liquid product into the container. The liquid product may be delivered to the nozzles from the filler bowl by gravity feed.

The valve is opened and closed to control the flow of liquid product that flows through the nozzle and into the container. Each filling station may fill a container with the nozzle located at the top of the container or may include a bottom-up fill arrangement. In either case, structure may be provided to seal against a top of the container during filling. The nozzles commonly include a vent path so that as liquid enters the container the air in the container is vented up through the nozzle and into the filler bowl above the liquid level in the filler bowl.

In order for the filling valve to function quickly when opened, air must be able to move upward along the vent path quickly. Small amounts of the liquid that is being filled into the containers can enter and remain in the vent path between sequential filling operations of the filling valve. When the valve is opened for a next fill, the presence of that small amount of liquid in the vent path can obstruct the venting of air temporarily, slowing down the operation of the filling valve. This situation tends to be more problematic in the case of more viscous liquids, but can also be a problem with low viscosity liquids. The entire filling system line can be slowed down by this issue.

Accordingly, it would be desirable to provide a filling valve assembly that is configured to more quickly clear any liquid that enters the vent path of the valve.

### SUMMARY

In one aspect, a filling valve assembly for use in association with a filler device for filling containers is provided. The filling valve assembly includes a nozzle defining a liquid outlet and an air inlet, a vent tube extending upward from the air inlet, and a lower valve part that is movable between a non-fill position the covers both the liquid outlet and the air inlet to prevent liquid flow out of the liquid outlet and a fill position that uncovers both the liquid outlet and the air inlet to allow liquid flow out of the liquid outlet during filling. The vent tube extends to a pressure condition assembly that is configured such that, as the lower valve part moves from the non-fill position to the fill position, the pressure condition assembly is adjusted such that a negative pressure condition is induced on the vent tube to draw air upward along the vent tube.

In another aspect, a filling valve assembly for use in association with a filler device is provided. The filling valve assembly includes a valve housing, a nozzle at a lower end of the filling valve assembly and defining a liquid outlet and an air inlet, the valve housing including a lower valve part that is movable between a non-fill position the covers both the liquid outlet and the air inlet to prevent liquid flow out of the liquid outlet and a fill position that uncovers both the liquid outlet and the air inlet to allow liquid flow out of the liquid outlet during filling. The air outlet is at a lower end portion of a vent tube that extends upward within the valve housing, wherein the vent tube extends to a pressure condition assembly that is configured such that, as the lower valve part moves from the non-fill position to the fill position, the pressure condition assembly is adjusted such that a negative pressure condition is induced on the vent tube to draw air upward along the vent tube.

In another aspect, a method is provided for controlling a filling valve assembly during a container filling operation, wherein the filling valve assembly includes a vent tube for venting air from the container during filling. The method involves utilizing upward movement of a valve component to create a negative pressure condition at an upper end of the vent tub to promote air movement upward through the vent tube as the filling valve assembly is being opened for filling.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of a filling valve assembly (vent tube extending upward from the valve assembly is not shown for convenience);

FIG. 2 is a section view of the filling valve assembly;

FIGS. 3-5 show section views of a nozzle end of the filling valve assembly;

FIG. 6 is a section view of the filling valve assembly connected to a filler bowl;

FIG. 7-8 are section views of upper parts of the filling valve assembly (upwardly extending vent tube not shown in FIG. 8);

FIGS. 9-13 are section views depicting a valve opening sequence during a container filling operation (vent tube extending upward from the valve assembly is not shown for convenience);

FIGS. 14-18 are section views of the upper part of the filling valve assembly during valve opening (vent tube extending upward from the valve assembly is not shown for convenience);

FIG. 19 show an alternative embodiment of a pressure condition assembly for a filling valve;

FIG. 20 shows a schematic view of the pressure condition assembly in a filler bowl;

FIG. 21 shows an alternative embodiment of a pressure condition assembly with an open top above the liquid level in the filler bowl;

FIG. 22 shows an alternative embodiment of a filling valve assembly;

FIGS. 23-24 show cross-section views of portions of the filling valve assembly;

FIG. 25 shows an alternative embodiment of a filling valve assembly; and

FIGS. 26-27 show cross-section views of portions of the filling valve assembly.

### DETAILED DESCRIPTION

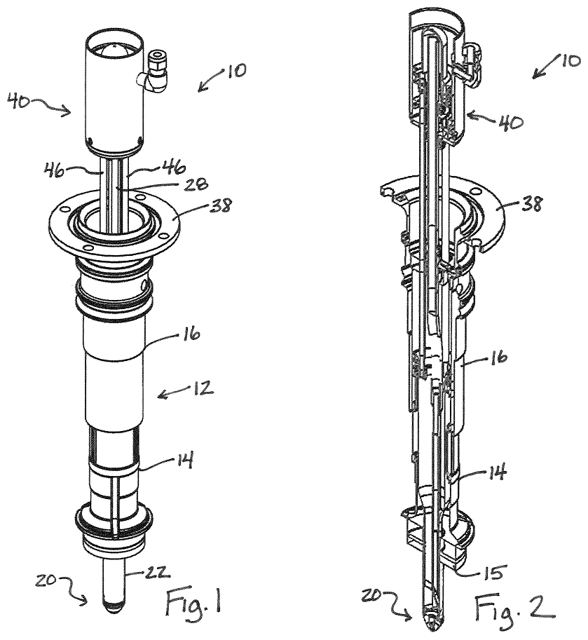

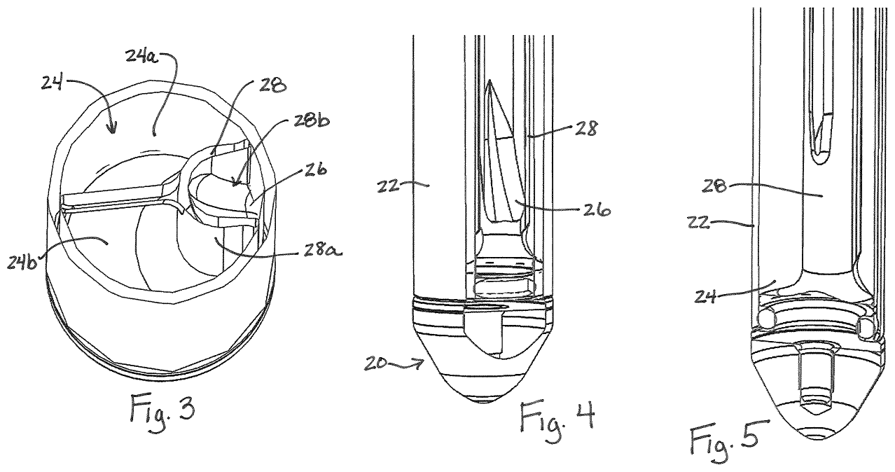

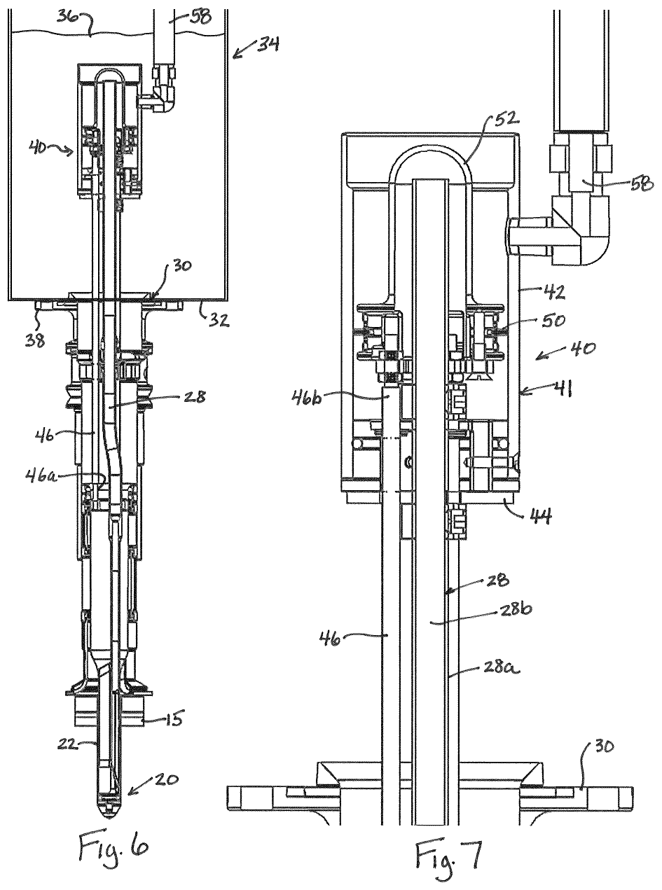

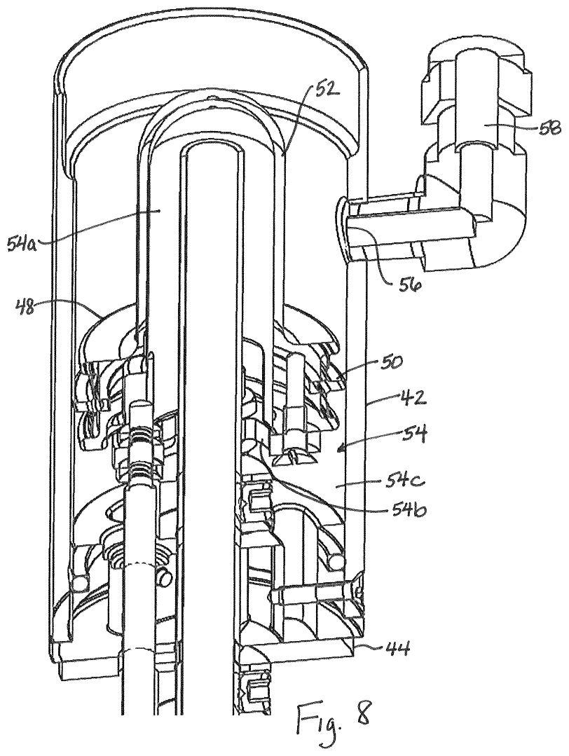

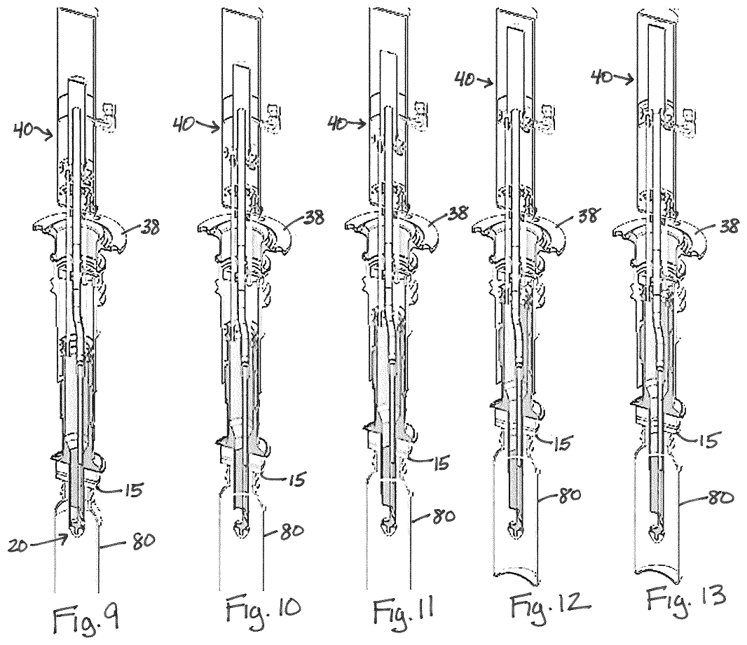

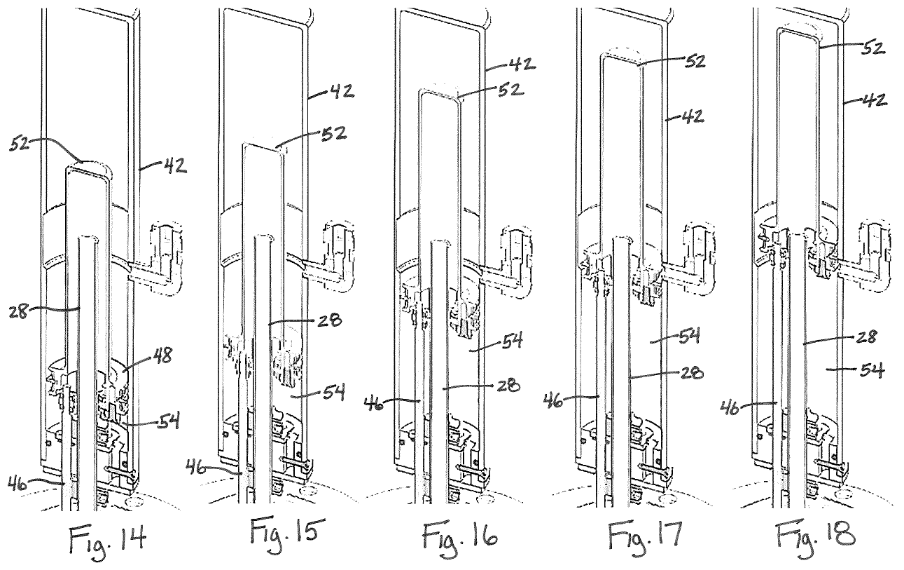

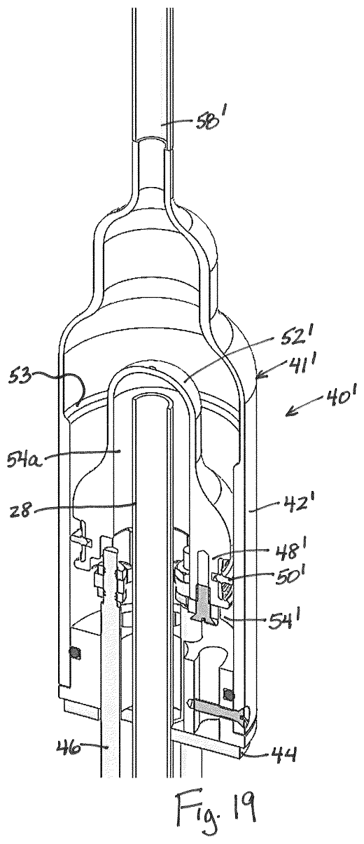

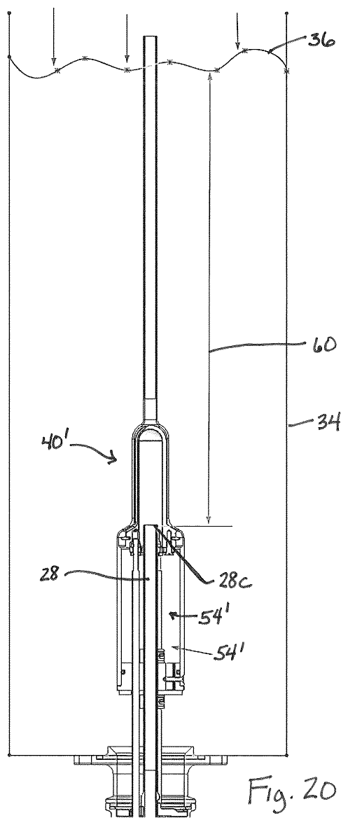

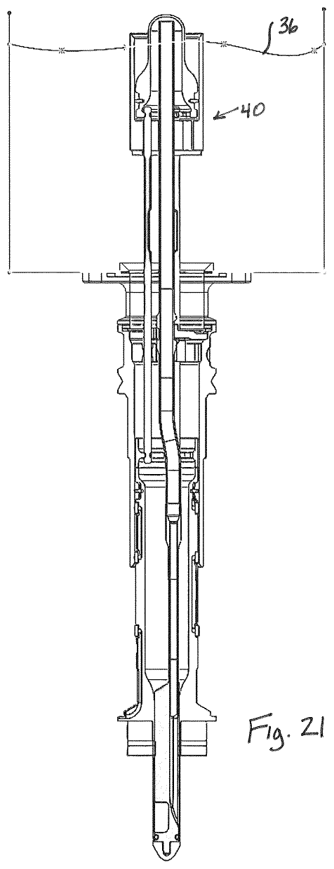

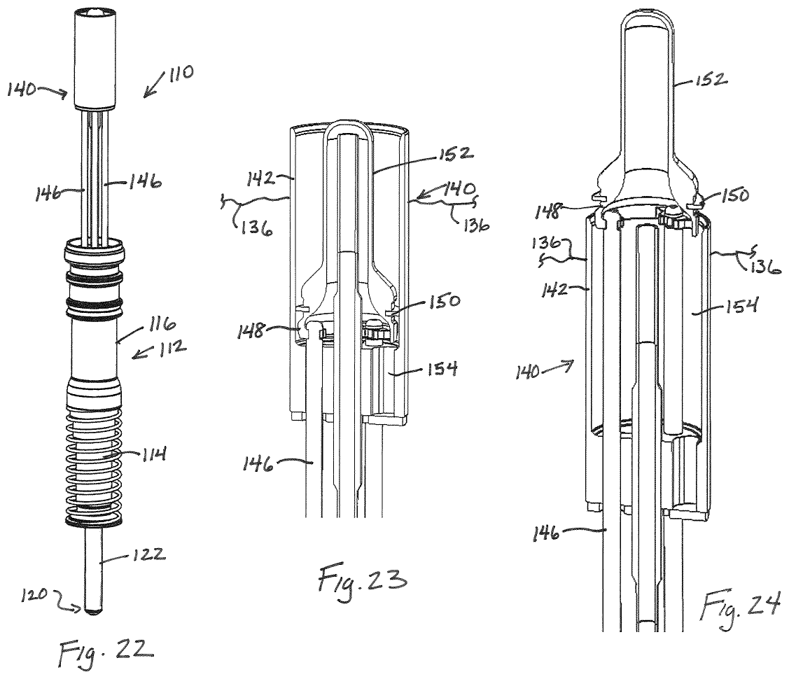

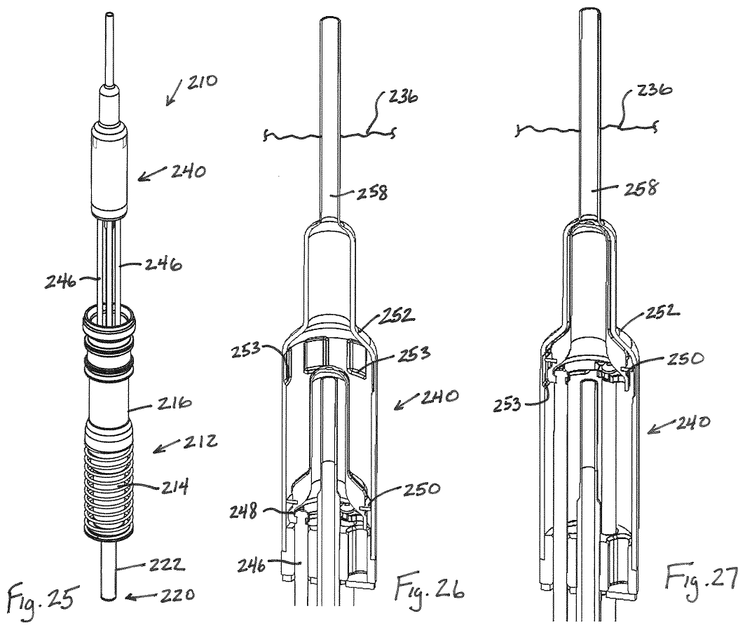

Referring to FIGS. 1-18, a filling valve assembly 10 includes a valve housing 12 with a lower part 14 and an upper part 16. An upper end of the lower part 14 is disposed axially within the lower end of the upper part 16, in a sealed manner, and is axially slidable relative the upper part 16 for controlling filling operations of the filling valve assembly. In this regard, a nozzle 20 is located at the lower end of the filling valve assembly, and the lower part 14 of the housing is formed in part by a tubular sleeve 22 that is disposed around a liquid outlet 24 of the valve and an air inlet 26 of the nozzle 20. The nozzle tip is connected at the lower end of a vent tube 28, and the air inlet is formed at a lower portion of the vent tube. The vent tube 28 extends upwardly through the housing 12. Here, the liquid outlet is formed by a region or regions 24a, 24b that are at an external side of the vent tube wall 28a that forms the vent path 28b. When the tubular sleeve 22 moves upward relative to the nozzle tip and the vent tube, the liquid outlet and the air inlet become uncovered, allowing liquid that is traveling downward within the valve housing 12, and externally of the vent path 28b, to exit the nozzle via the liquid outlet 24, and allowing air to enter the air inlet 26, as needed for a gravity feed container filling operation.

In use, the filling valve assembly 10 is typically connected to an opening 30 in a bottom wall 32 of a filler bowl 34 that holds the liquid 36 that can move down through the housing 12 for the purpose of container filling. A bowl mount flange 38 is provided at the upper end of the housing 12 for this purpose. The vent tube 24 also extends upward through the opening and within the filler bowl 34, and extends into a pressure condition assembly 40.

The pressure condition assembly 40 includes a housing 41 with an exterior chamber assembly wall 42, and a bottom valve 44, which may be substantially sealed around the vent tube 28. The valve 44 may, for example, be a flexible membrane or a solid material check valve that sufficiently seals when a pressure condition above the valve 44 and in the housing 41 is less than a pressure condition outside the housing (preventing contents of the filler bowl from entering the housing), and that unseals when the pressure condition above the valve 44 and in the housing 41 is higher than the pressure condition outside the housing. One or more chamber control links 46, here in the form of rods, have lower ends 46a that are connected to the lower part 14 of the housing for movement therewith, and upper ends 46b that are connected to an annular (or other shaped) internal chamber wall 48 within the housing wall 42 and running about the vent tube 28. The valve 44 may also be substantially sealed around the chamber control links 46. The annular internal chamber 48 carries one or more seals 50 for sealing against an internal surface of the exterior chamber assembly wall 42, and operates as a plunger. A dome shaped tube cover 52 is connected to, or formed as part of, the annular internal chamber 48, such that a sealed chamber 54 is formed by a space 54a between the vent tube 28 and the dome shaped cover 52, a space 54b between the annular internal chamber 48 and the vent tube 28, and an annular space 54c below the annular internal chamber 48 and above the bottom wall 44.

Per FIGS. 9-18, during a filling operation of a container 80, the container is moved upward such that the nozzle 20 moves into the container and the upper edge of the container engages on a seal 15 of the lower housing part 14. Continued upward movement of the container 80 pushes lower housing part 14 upward to open the feed valve. As the lower part 14 of the housing 12 moves upward to expose the liquid outlet 24 and the air inlet 26, the chamber control links 46 also move upward, causing the annular internal chamber 48 and dome cover 52 to move upward within the exterior chamber assembly wall 42, which causes a volume of the chamber 54 to increase. Due the sealed arrangement of the chamber 54 relative to the chamber assembly wall 42, this increase in the volume of the chamber 54 creates a negative pressure condition (a reduced pressure condition as compared to pressure at the bottom of the vent tube) that will tend to draw air upward through the vent tube 28. The negative pressure induced air draw through the vent tube 28 helps quickly clear an air path through any residual liquid in the lower end of the vent tube 28, allowing liquid to exit through the liquid outlet of the nozzle more quickly.

Here, an outlet 56 is provided in the chamber assembly wall 42. The seal 50 carried by the annular internal chamber 48 is located below the outlet 56 during a majority of its movement distance, but, during container filling, moves above the outlet 56 to expose the chamber 54 to a vent tube/path 58 via the outlet 56. This vent tube/path 58 extends to a location above the level of the liquid in the filler bowl for venting purposes. Thus, the annular internal chamber 48 is movable by a set distance, between a minimum chamber volume position (FIG. 14) when the lower valve part 14 is in a non-fill position (FIG. 9) and a maximum chamber volume position (FIG. 18) when the lower valve part 14 is in a fill position (FIG. 13). The seal arrangement 50 seals the chamber during movement of the annular internal chamber 48 along the major part of the set distance, but the seal 50 moves upward past the chamber outlet opening 56 to reach the maximum chamber volume position, allowing air moving up the vent tube 28 and into the chamber 54 to vent, via opening 56 and vent path 58, from the filling valve assembly into the filler bowl. Foam and/or overflow from the filling process can also be collected in the chamber 54 during this sequence.

Notably, after completion of a container fill operation, as the lower part 14 of the valve housing is moving back down to close off the liquid outlet 24 and the air inlet 26, the annular internal chamber 48 also moves downward, decreasing the volume of the chamber 54. Air and liquid product (foam/overflow) that is in the chamber 54 will be purged downward through the valve 44 (and into the filler bowl) during this sequence.

Other arrangements for inducing the desired pressure conditions on the vent tube 28 are possible. For example, a variation having a stationary plunger fixed to the vent tube, and in which the outer housing moves up and down relative to the plunger, could be implemented to create the desired negative pressure condition.

In another variation, per FIG. 19, a pressure condition assembly 40′ includes a vent 58′ that is located at and/or extends through a top of the housing 41′. In this embodiment, the chamber 54′ becomes open to the vent path 58′ when the seal 50′ moves upward past a radially outer/outward step 53 of the inner surface of the housing wall 42′. Thus, the negative pressure condition would be induced as the seal 50′ moves upward with the internal chamber wall 48′ and dome cover 52′, until the seal 50′ passes upward beyond the step 53. Operation of the pressure condition assembly 40′ is otherwise similar to that of pressure condition assembly 40, with the plunger being shifted by one or more links 46, with the vent tube 28 extending into the pressure condition assembly housing 41′ and having a top 28c, and with path 54a and valve 44 provided.

FIG. 20 shows the pressure condition assembly 40′ submerged below the liquid level 26 of a filler bowl 34. Notably, during filling, the head pressure in the filler bowl pushes the liquid down through the valve into the container to be filled. As shown here, with the pressure condition assembly 40′ submerged, a differential head pressure 60 is created between the liquid level 26 and the top of the vent tube 28, and this differential head pressure allows faster “foam” or “overflow” evacuation from the bottle upward through the vent tube 28, as compared to systems in which the vent tube itself extends above the liquid level.

FIG. 21 shows another embodiment in which the top of the chamber 40 is above the liquid level 36 in the filler bowl, and open to the internal filler bowl atmosphere.

FIGS. 22-24 show an embodiment of a filling valve assembly 110 with valve housing 112 (with upper and lower housing parts 114, 116), nozzle 120 and tubular sleeve 122. A pressure condition assembly 140 is configured with a simplified connection between the control link(s) 146 and the internal chamber wall 148 (with integrated dome cover 152). In this embodiment, when the lower part of the valve housing is moved up to the fill position, the seal 150 moves above a top edge of the exterior chamber assembly wall 142 in order to create the vent path for the chamber 154. In this embodiment, the filling valve assembly 110 is to be installed on the filler bowl with the top edge of the exterior chamber assembly wall 142 above the liquid level 136 of the filler bowl.

FIGS. 25-27 show an embodiment of a filling valve assembly 210 with valve housing 212 (with upper and lower housing parts 214, 216), nozzle 220 and tubular sleeve 222. A pressure condition assembly 240 is configured with a simplified connection between the control link(s) 246 and the internal chamber wall 248 (with integrated dome cover 252). In this embodiment, a tubular vent path 258 extends upwardly from the top of the dome cover 252. When the lower part of the valve housing is moved up to the fill position, the seal 250 moves above a radially outer step 253 (or stepped regions) of the exterior chamber assembly wall 242, per FIG. 27, in order to fluidly connect the chamber 254 to the vent path 258. In this embodiment, the filling valve assembly 210 can be installed on the filler bowl with the entire exterior chamber assembly wall 242 submerged, and with the vent path 258 extending above the liquid level 236 of the filler bowl.

It is to be clearly understood that the above description is intended by way of illustration and example only, is not intended to be taken by way of limitation, and that other changes and modifications are possible. For example, embodiments in which the entirety of the chamber is above the liquid level in the bowl could be implemented.

1. A filling valve assembly for use in association with a filler device, the filling valve assembly comprising:
a valve housing;
a nozzle at a lower end of the filling valve assembly and defining a liquid outlet and an air inlet;
the valve housing including a lower valve part that is movable between a non-fill position the covers both the liquid outlet and the air inlet to prevent liquid flow out of the liquid outlet and a fill position that uncovers both the liquid outlet and the air inlet to allow liquid flow out of the liquid outlet during filling;
wherein the air outlet is at a lower end portion of a vent tube that extends upward within the valve housing, wherein the vent tube extends to a pressure condition assembly that is configured such that, as the lower valve part moves from the non-fill position to the fill position, the pressure condition assembly is adjusted such that a negative pressure condition is induced on the vent tube to draw air upward along the vent tube.

2. The filling valve assembly of claim 1, wherein the pressure condition assembly comprises a chamber having a chamber volume that increases as the lower valve part moves from the non-fill position toward the fill position such that, as the chamber volume increases, the negative pressure condition is created to draw air upward along the vent tube.

3. The filling valve assembly of claim 2 wherein the chamber of the pressure condition assembly includes a valve through which air and liquid may be purged as the chamber volume decreases and that seals during increase in the chamber volume.

4. The filling valve assembly of claim 2, wherein the chamber is defined in part by an internal chamber wall that is connected to move, as the lower valve part moves, for varying the chamber volume.

5. The filling valve assembly of claim 4, where the internal chamber wall is movable by a set distance between a minimum chamber volume position when the lower valve part is in the non-fill position and a maximum chamber volume position when the lower valve part is in the fill position, wherein the internal chamber wall has a seal arrangement that seals the chamber during movement of the internal chamber wall along part of the set distance, wherein the seal moves to a location to fluidly expose the chamber volume to a chamber outlet opening to reach the maximum chamber volume position, allowing air moving up the vent tube and into the chamber volume to vent from the filling valve assembly.

6. The filling valve assembly of claim 5, wherein filling valve assembly is connected to a filler bowl, wherein the nozzle and the lower valve part are positioned externally of the filler bowl, wherein the chamber is located internally of the filler bowl, and the chamber outlet opening is connected to a vent path that extends above a liquid level in the filler bowl.

7. The filling valve assembly of claim 6, wherein a link extends upward from the lower valve part, through a wall of the filler bowl, into the chamber and into engagement with the internal chamber wall for effecting movement of the internal chamber wall as the lower valve part moves.

8. The filling valve assembly of claim 1, wherein the lower valve part comprises a tubular sleeve and a container engaging seal, wherein the tubular sleeve is disposed about the liquid outlet and the air inlet when the lower valve part is in the non-fill position, wherein the tubular sleeve extends downward from the container engaging seal, wherein upward movement of a container into contact with the container engaging seal urges the lower valve part, including the tubular sleeve, upward.

9. A filling system, including the filling valve assembly of claim 2, comprising:
a filler bowl for holding a liquid that can be fed downward through the filling valve assembly;
wherein the filling valve assembly is mounted such that the nozzle is located below the filling valve assembly and the chamber is located within the filler bowl.

10. The filling system of claim 9, wherein at least part of the chamber is located below a liquid level within the filler bowl.

11. A method of controlling a filling valve assembly during a container filling operation, wherein the filling valve assembly includes a vent tube for venting air from the container during filling, the method comprising:
utilizing a movement of a valve component to create a negative pressure condition at an upper end of the vent tube to promote air movement upward through the vent tube as the filling valve assembly is being opened for filling.

12. The method of claim 11, wherein the negative pressure condition is induced by increasing a volume of a chamber fluidly associated with the upper end of the vent tube.

13. The method of claim 12, wherein the chamber is located within a filler bowl.

14. The method of claim 13, wherein at least part of the chamber is located below a liquid level within the filler bowl.

15. The method of claim 12, wherein the movement is a movement of the valve component along a chamber of the filling valve assembly.

16. A filling valve assembly for use in association with a filler device for filling containers, the filling valve assembly comprising:
a nozzle defining a liquid outlet and an air inlet;
a vent tube extending upward from the air inlet;
a lower valve part that is movable between a non-fill position the covers both the liquid outlet and the air inlet to prevent liquid flow out of the liquid outlet and a fill position that uncovers both the liquid outlet and the air inlet to allow liquid flow out of the liquid outlet during filling;
wherein the vent tube extends to a pressure condition assembly that is configured such that, as the lower valve part moves from the non-fill position to the fill position, the pressure condition assembly is adjusted such that a negative pressure condition is induced on the vent tube to draw air upward along the vent tube.

17. The filling valve assembly of claim 16, wherein the pressure condition assembly comprises a chamber having a chamber volume that increases as the lower valve part moves from the non-fill position toward the fill position such that, as the chamber volume increases, the negative pressure condition is created to draw air upward along the vent tube.

18. The filling valve assembly of claim 17, wherein the chamber is defined in part by an internal chamber wall that is connected to move, as the lower valve part moves, for varying the chamber volume.

19. The filling valve assembly of claim 18, where the internal chamber wall is movable by a set distance between a minimum chamber volume position when the lower valve part is in the non-fill position and a maximum chamber volume position when the lower valve part is in the fill position, wherein the internal chamber wall has a seal arrangement that seals the chamber during movement of the internal chamber wall along part of the set distance, wherein the seal moves to a location to fluidly expose the chamber volume to a chamber outlet opening to reach the maximum chamber volume position, allowing air moving up the vent tube and into the chamber volume to vent from the filling valve assembly.

20. The filling valve assembly of claim 19, wherein:
the filling valve assembly is connected to a filler bowl, wherein the nozzle and the lower valve part are positioned externally of the filler bowl, wherein the chamber is located internally of the filler bowl; and
a link extends upward from the lower valve part, through a wall of the filler bowl, into the chamber and into engagement with the internal chamber wall for effecting movement of the internal chamber wall as the lower valve part moves.
